(19) United States
(12) Patent Application Publication
(10) Pub. No.: US 2009/0172007 A1
(43) Pub. Date: Jul. 2, 2009

(54) IMPLEMENTING APPLICATIONS WITH A DATA MODEL COMPRISING CONTENT, THREAD AND CATEGORY

(76) Inventors: Jonathan Ding, Shanghai (CN); Bo Huang, Shanghai (CN); Wenjie Zhang, Shanghai (CN)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/968,071

(22) Filed: Dec. 31, 2007

(51) Int. Cl. G06F 17/00

(52) U.S. Cl. 707/102

(57) ABSTRACT

Embodiments of plural application implementations in accordance with a unified data model are disclosed herein. A unified data model 102 may comprise contents104, threads 106 of contents, and categories 108 of threads, to which most application data are organized accordingly. Applications 110 may have extended data. Additionally, services 120 are pre-defined/provided to operate on data organized in accordance with the unified data model 102, including services to operate on contents 122, services to operate on threads 124 and services to operate categories 126. In various embodiments, a facility/utility may be further provided to instantiate a security database 130 for storing security settings for all or selected data items organized in accordance with the unified data model 102.

### TECHNICAL FIELD

Embodiments of the present invention relate to the field of data processing, in particular, implementation of applications using a data model having a content, thread and category organization.

### BACKGROUND

As Internet related technologies continue to develop, more and more websites are gradually transformed from merely containing isolated information provided by the website owners to including contents generated and distributed by users of the websites. Not only traditional types of contents such as pictures, texts or videos are uploaded to such websites, new content types such as really simple syndication (RSS) feeds are generated as new web applications emerge. So, new data model and new application programming interfaces (APIs) and even specific services have to be designed correspondingly for the different new types of content and implementations of the new applications. However, due to different data models adopted, developers of new applications may not be able to benefit from what other developers have already established. On the other hand, new applications using techniques such as Mashup and SaaS (Software as a Service) require a high level of interoperability between websites so that data can be exchanged easily to implement the desired applications.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of plural applications implemented with a unified data model, according to various embodiments;

FIG. 2 illustrates an overview of the unified data model according to various embodiments;

FIG. 3 shows an example of a content in the unified data model according to various embodiments;

FIG. 4 shows an example of a thread in the unified data model according to various embodiments;

FIG. 5 shows an example of a category in the unified data model according to various embodiments;

FIG. 6 shows an example of a security database compatible with the unified data model according to various embodiments; and

FIG. 7 illustrates an example computer system suitable for practicing embodiments of the invention.

### DETAILED DESCRIPTION OF ILLUSTRATIVE EMBODIMENTS

Illustrative embodiments of the present invention include, but are not limited to, methods and apparatuses for implementing plural applications based on a unified data model. In various embodiments, the unified data model comprises contents, threads of contents, and categories of threads.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in various embodiments” is used repeatedly. The phrase generally does not refer to the same embodiment; however, it may. The terms “comprising,” “having,” and “including” are synonymous, unless the context dictates otherwise.

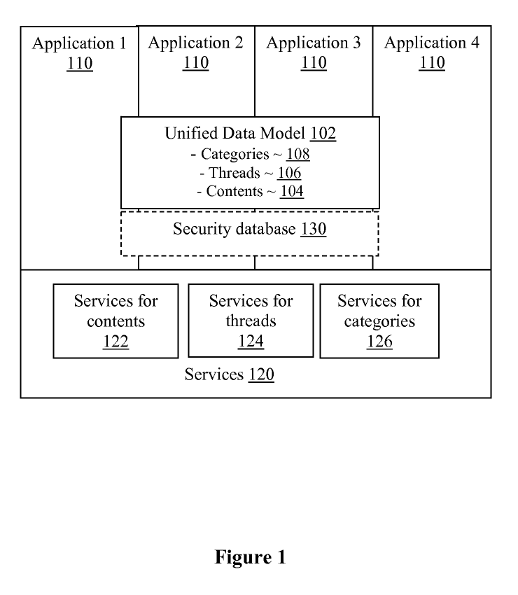

FIG. 1 illustrates an overview of plural applications 110 implemented with a unified data model 102, according to various embodiments. As illustrated, for the embodiments, application data of each of a plurality of applications 110, whether they are developed by the same or different developers/owners, have different features or provide different services or not, are substantially organized in accordance with unified data model 102 with contents 104, threads of contents 106 and categories of threads 108. Each application 110, as will be explained in more details below, may have additional data extended beyond the unified data model 102. The data, whether defined by the model or extended, may be commonly or separately stored. Regardless of the manner of storage, as a result of the substantial common organization, data of applications 110 are more readily sharable among the applications. Examples of applications 110 may include, but are not limited to blog, album and RSS applications.

Additionally, for the embodiments, applications 110 utilize a set of uniformly pre-defined/provided services 120 comprising services for contents 122, services for threads 124 and services for categories 126 to manipulate and operate on the data defined in accordance with unified data model 102. Therefore, according to various embodiments, no matter if the services are web services provided by remote providers or services offered by the applications 110, they don't have to be specifically designed for various types of applications 110.

In various embodiments, there may also be a security database 130 which contains security settings defined by applications 110 or users of applications 110, for all or selected ones of the various data items defined/organized in accordance with the unified data model 102.

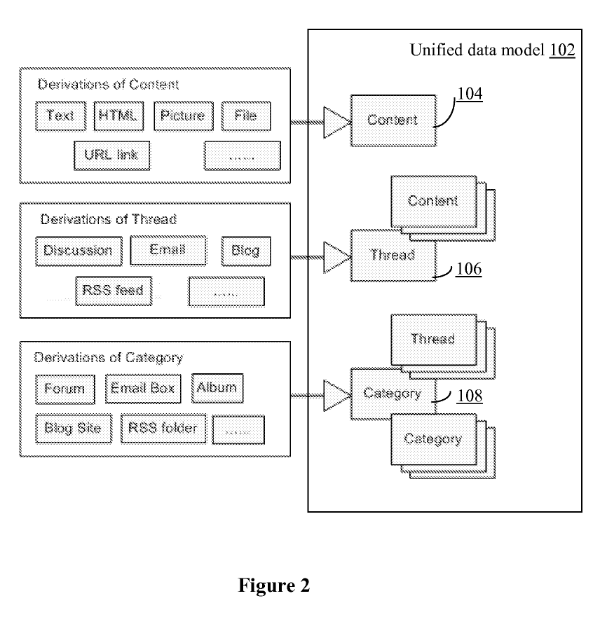

FIG. 2 shows an overview of the unified data model 102 in further details, according to various embodiments. As illustrated, for the embodiments, each content 104 may be one of texts, graphic primitives, audio blocks, images, video frames, files, links, and so forth. Each thread 106 may be a session of multi-user discussion, a chain of e-mails, a post with annotated comments, a RSS feed, and so forth. Each category 108 may be a forum, an e-mail box, an album, a blog site, a RSS folder, and so forth. In alternate embodiments, there may be more or less content types, more or less thread types, and/or more or less category types.

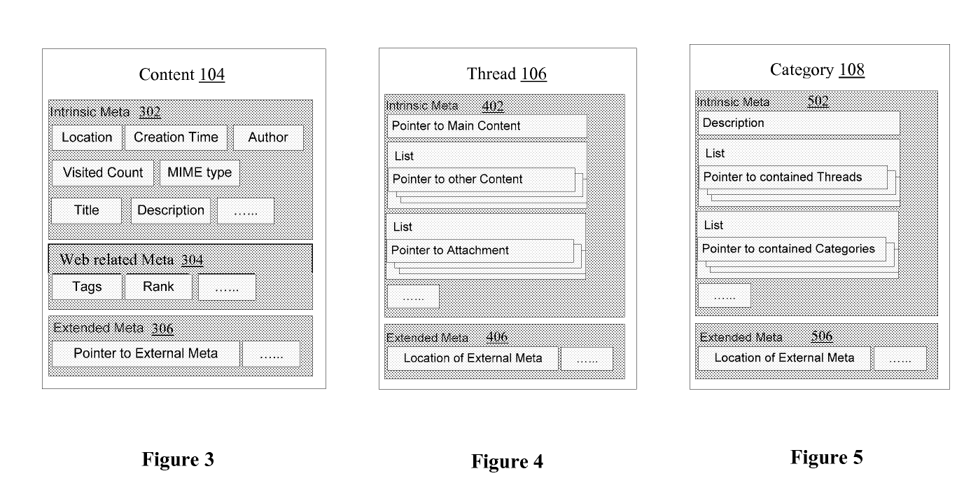

FIG. 3 illustrates the reference design of a content 104 in further details, according to various embodiments. As illustrated, for the embodiments, each content 104 may comprise intrinsic metadata 302, web related metadata 304, and extended metadata 306. For the illustrated embodiments, intrinsic metadata 302 of a content 104 may comprise the location information of the content. In various embodiments, the location information could be a URL address, or a path for the local file system, or an ID in a database. In various embodiments, the intrinsic metadata 302 of a content 104 may also comprise creation time, authorship, visited count, title or description of the content. The web related metadata 304 of a content 104 may include tags or ranks of the content. The extended metadata 306 of a content 104 may include one or more pointers to external metadata which may be especially useful for a picture, a HTML, a text, and so forth. In alternate embodiments, each content 104 may comprise more or less metadata.

FIG. 4 illustrates the reference design of a thread 106, accordance to various embodiments. Similar to content 104, as illustrated, a thread 106 may comprise intrinsic metadata 402 and extended metadata 406. Instead of storing metadata of a particular content, the intrinsic metadata 402 of thread 106 may comprise pointer information to contents and attachments. In various embodiments, the intrinsic metadata 402 of a thread 106 may comprise a pointer to a main content 104 that the thread 106 is mainly related to, and a list of pointers to other contents 104, as well as a list of pointers to various attachments. In alternate embodiments, each thread 106 may comprise more or less metadata.

FIG. 5 illustrates the reference design of a category 108, according to various embodiments. As illustrated, for the embodiments, a category 108 may also comprise intrinsic metadata 502 and extended metadata 506. The intrinsic metadata 502 of a category 108 may comprise a description of the category, a list of pointers to the contained threads 106 and even a list of pointers to other categories or categories subordinate to categories 108. In various embodiments, each category 108 may comprise more or less metadata.

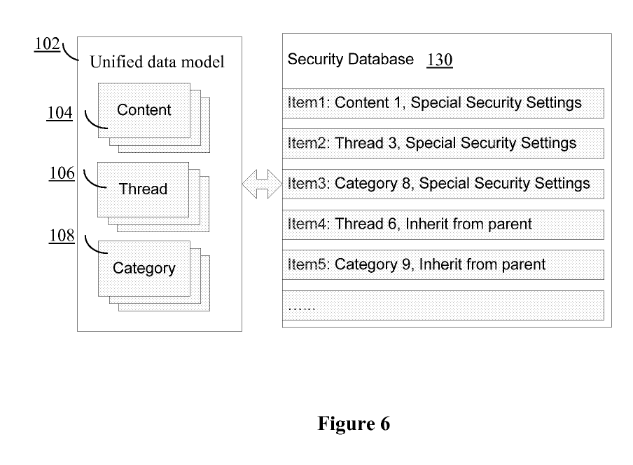

FIG. 6 illustrates security database 130 in further details, in accordance with various embodiments. As illustrated, for the embodiments, security database 130 may contain corresponding security settings for all or selected ones of contents 104, threads 106 and categories 108. These security settings may be defined by the unified data model 102. Depending on implementations and/or particular data items, the defined security settings may or may not be override-able by an application 110 and/or users of the application 110. In various embodiments, a utility (not shown) may be provided to assist an application developer to instantiate a private security database, if desired. For example, it may be a utility to assist an application developer to instantiate a structured query language (SQL) database to store security settings for all or selected ones of the data items of an application 110 organized in accordance with the unified data model 102.

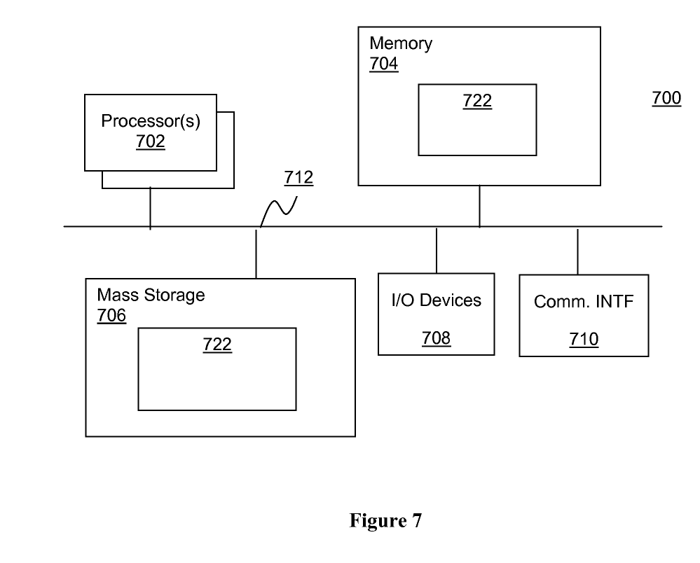

FIG. 7 illustrates an example computer system suitable for use to practice various embodiments of the present invention. It may be a server or a client device to implement the plural applications, associated with the services that operate on the contents, threads and categories organized in accordance with the unified data model, and/or a security database. As shown, computing system 700 includes one or more processors 702, and system memory 704. Additionally, computing system 700 includes mass storage devices 706 (such as diskette, hard drive, CDROM and so forth), input/output devices 708 (such as keyboard, cursor control and so forth) and communication interfaces 710 (such as network interface cards, modems and so forth). The elements are coupled to each other via system bus 712, which represents one or more buses. In the case of multiple buses, they are bridged by one or more bus bridges (not shown).

Each of these elements performs its conventional functions known in the art. In particular, system memory 704 and mass storage 706 may be employed to store a working copy and a permanent copy of the data and/or instructions associated with embodiments of the invention, including but are not limited to: data organized as contents 104, threads 106 and categories 108 in accordance with the unified data model 102; services 122 to operate on contents, services 124 to operate on threads and services 126 to operate on categories; security database 130 for storing security settings defined for all or selected data items organized in accordance with the unified data model 102; and applications 110, collectively called 722. The various components may be implemented as assembler instructions supported by processor(s) 702 or high level languages, such as C, that can be compiled into such instructions.

The permanent copy of the programming instructions may be placed into permanent storage 706 in the factory, or in the field, through, for example, a distribution medium (not shown), such as a compact disc (CD), or through communication interface 710 (from a distribution server (not shown)).

The constitution of these elements 702-712 are known, and accordingly will not be further described. And in accordance with various embodiments, a cluster of computing systems 700 may work together to distribute data and provide services to users, even remote ones.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. An article of manufacture comprising
storage medium; and
a plurality of programming instructions stored in the storage medium configured to program and implement an application on an apparatus, the programming instructions organizing data of the application in accordance with a data model that comprises contents, threads of contents and categories of thread.

2. The article of claim 1 wherein the programming instructions implement the application with a content that is a selected one of one or more texts, graphics primitives, audio blocks, images, video frames, files, or links.

3. The article of claim 1 wherein the programming instructions implement the application with a thread of contents that is a selected one of a session of a multi-user discussion, a chain of emails, or a post with annotated comments, or a really simple syndication (RSS) feed.

4. The article of claim 1 wherein the programming instructions implement the application with a category of threads that is a selected one of a forum, an email box, an album, a blog site, or a really simple syndication (RSS) folder.

5. The article of claim 1 wherein the programming instructions implement the application with a content having a plurality of intrinsic metadata including one or more of a location, a creation time, an author, a visited count, a Multipurpose Internet Mail Extension (MIME) type, a title, or a description of the content.

6. The article of claim 5, wherein the content further comprises a plurality of web related metadata including one or more tags or rank of the content.

7. The article of claim 6, wherein the content further comprises a plurality of extended metadata including one or more pointers to one or more external metadata.

8. The article of claim 1, wherein the programming instructions further implement the application with a thread of contents having a plurality of intrinsic metadata including a pointer to a main content, and one or more lists of pointers to other contents or attachments.

9. The article of claim 8, wherein the thread of contents further comprises a plurality of extended metadata including one or more pointers to one or more external metadata.

10. The article of claim 1, wherein the programming instructions further implement the application with a category of threads having a plurality of intrinsic metadata including a description of the category, and one or more lists of pointers to one ore more threads or other categories.

11. The article of claim 10, wherein the thread of content further comprises a plurality of extended metadata including one or more pointers to one or more external metadata.

12. The article of claim 1, wherein the programming instructions further implement the application with a security database comprising one or more corresponding security settings for one or more contents, threads or categories of the application.

13. The article of claim 1, wherein the programming instructions further implement one or more content services to operate on contents, thread services to operate on threads or category services to operate on categories.

14. A method comprising:
providing one or more services for a content item for development and implementation of one or more applications in accordance with a data model having content, threads of contents and categories of threads;
providing one or more services for a thread; and
providing one or more services for a category.

15. The method of claim 14, wherein the method further comprises providing a facility to instantiate a security database for an application to store one or more corresponding security settings for one or more contents, threads or categories of the application.

16. The method of claim 14, further comprising developing an application in accordance with the data model using the one or more services for contents, threads and categories.

17. The method of claim 16, further comprising developing another different application in accordance with the same data model using the one or more services for contents, threads and categories.
